(19) United States
(12) Patent Application Publication
(10) Pub. No.: US 2006/0211575 A1
(43) Pub. Date: Sep. 21, 2006

(54) CONTROL FOR PLANT AND PLANT PRODUCT PATHOGENS

(75) Inventors: Frederick S. Sedun, Saanichton, BC (CA); Hellmut Kulenkampff, Hamelin (DE); Diana L. Parker, Brentwood Bay, BC (CA); George S. Puritch, Saanichton, BC (CA)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: W. NEUDORFF GMBH KG, Emmerthal 1 (DE)

(21) Appl. No.: 10/907,010

(22) Filed: Mar. 16, 2005

(51) Int. Cl. A01N 65/00; A01N 63/00; A01N 43/04; A01N 37/30; A01N 59/20; A01N 25/26

(52) U.S. Cl. 504/100; 514/28; 514/65; 424/638; 424/761; 424/93.461; 514/554

(57) ABSTRACT

An environmentally safe, pesticidally effective composition is provided to treat and/or prevent plant or plant product damage caused by bacterial and fungal plant pathogens. In an exemplary embodiment, a composition is provided that includes a pesticidally effective concentration of at least one betaine as well as at least one solvent.

### FIELD OF THE INVENTION

The present invention relates to compositions and methods for treatment of fungi and bacteria on plants and plant products, and in particular to compositions and methods that protect plants and plant products from damage caused by bacterial and fungal pathogens.

### BACKGROUND OF THE INVENTION

Bacterial and fungal pathogens cause significant losses to plants and plant products both in the field and after harvest. Pesticides are widely used in crop production and on plant products, such as lumber, to reduce these losses. However, as of late, many of these compositions are being withdrawn from the market due to toxicological concerns or loss of efficacy as a result of fungi developing resistance to these active ingredients.

Accordingly, there remains a need for an improved composition to treat and prevent plant and plant product damage caused by bacterial and fungal plant pathogens.

### BRIEF SUMMARY OF THE INVENTION

The present invention provides various compositions and methods to protect plants and plant products from damage caused by bacterial and fungal plant pathogens. In one exemplary embodiment, a plant and plant product treatment composition is provided having a pesticidally effective amount of at least one betaine and at least one solvent, such that the pesticidal composition is effective to kill bacterial and fungal plant pathogens without damaging or degrading the host (i.e., the plant or the plant product). The betaine can have a linear or branched alkyl group, and the alkyl group can have in the range of about 5 to 20 carbon atoms.

In another embodiment, the composition can further include one additional fungicide or pesticide selected from the group consisting of copper preparations, fatty acids and/or salts, sulfur preparations, neem extracts, sodium and potassium carbonates, essential oils, mineral oils, vegetable oils, and combinations thereof. Alternatively, the composition can further include at least one insecticide selected from the group consisting of natural pyrethrums, pyrethroids, spinosyns, microbial compounds including Bacillus spp., and combinations thereof, or one metal ion or a mixture of metal ions selected from the group consisting of calcium, magnesium, manganese, iron, copper, nickel, zinc, aluminum, silver, titanium, and combinations thereof.

Moreover, the composition can optionally include at least one other compound selected from the group consisting of growth regulators, fertilizers, fungicides, thickening agents, humectants, antioxidants, surfactants, stabilizing agents, wetting agents, fungicide synergists, sequestrants, dyes, insecticides, miticides, and combinations thereof.

In another aspect, a method for the control of plant or plant product pathogens is provided that includes providing a composition having a pesticidally effective amount of at least one betaine, and contacting a plant or a plant product with a pesticidally effective amount of the composition, such that the plant or plant product is protected against pathogens without causing injury. The betaine can have a linear or branched alkyl group, and the alkyl group can have in the range of about 6 to 20 carbon atoms.

In another embodiment, the method can further include the addition of another fungicide to the composition. The fungicide can be selected from the group consisting of copper preparations, fatty acids and/or salts, sulfur preparations, neem extracts, sodium and potassium carbonates, mineral oils, vegetable oils, essential oils, and combinations thereof. Alternatively, the method can further include the addition of at least one insecticide, such as natural pyrethrums, pyrethroids, spinosyns, microbial compounds including Bacillus spp., and combinations thereof, or the addition of one metal ion or a mixture of metal ions selected from the group consisting of calcium, magnesium, manganese, iron, copper, nickel, zinc, aluminum, silver, titanium, and combinations thereof.

Moreover, the method can include the addition of at least one other compound selected from the group consisting of growth regulators, fertilizers, fungicides, thickening agents, humectants, antioxidants, surfactants, stabilizing agents, wetting agents, fungicide synergists, sequestrants, dyes, insecticides, miticides, and combinations t

### DETAILED DESCRIPTION OF THE INVENTION

The present invention provides an environmentally safe, and pesticidally effective composition to treat and prevent damage caused by bacterial and fungal plant and plant product pathogens. In an exemplary embodiment, a composition is provided that includes a pesticidally effective concentration of at least one betaine as well as at least one solvent. One skilled in the art will appreciate that the compositions and methods disclosed herein can be used to treat a variety of bacterial and fungal plant and plant product pathogens, such as, by way of non-limiting example, rose blackspot (Diplocarpon rosae) on roses, rust (Cronartium sp.) on black currant, mildew (Sphaerotheca fuliginea) on dandelion, powdery mildew (Sphaerotheca fuliginea) on cucumber plants, grey mold (Botrytis cinerea) on strawberries, brown mold (Monilinia fructicola) on plums, wood surface molds including Penicillium, Aspergillus, Fusarium, Rhizopus, Trichoderma, Cephaloascus, Chaetomium, and Chalara, sapwood-staining fungi of the genera Ceratocystis, Alternaria, Hypoxylon, Xylaria, Graphium, Diplodia, Cladosporium, Aureobasidium, Phialophora, and Ophistoma, and wood-rotting fungi of the genera Poria, Peniophora, and Lenzites.

As noted above, in one embodiment, the composition includes at least one betaine and at least one solvent. While an exemplary composition includes one betaine, the composition can also include other betaines. The betaines are derivatives of alkyl amidopropyl dimethylamine that is a homolog of trimethyl glycinate (a compound that occurs naturally in the juice of the sugar beet). The betaines can be classified as amphoteric, however the betaines are in a special class of amphoterics since they can exist in only two forms, cationic and isoelectric (‘true’ amphoterics exist in three forms). Moreover, the betaine can have a positively charged nitrogen atom, a carboxylic acid group that has a negative charge at neutral or alkaline pH, and a carbon side chain. In an exemplary embodiment, the alkyl portion of the betaine can be saturated or unsaturated, and have a range of about 5 carbon atom to 20 carbon atoms, and more preferably have a range of about 16 carbon atoms to 18 carbon atoms. Moreover, the betaine can be either in granular or liquid form. The betaines can be naturally occurring or they can be chemically synthesized.

In one embodiment of the present invention, cetyl (C16) betaine, known chemically as 1-hexadecanaminium,N-(carboxymethyl)N,N-dimethyl-, inner salt (CAS number 693-33-4), can be used to form the composition. While the cetyl betaine can be synthesized by any means known in the art, it is also commercially available, such as in the De Taine PB composition provided by the Deforest Enterprises FL, USA, which consists of a non-alcoholic solution of 20-25% cetyl betaine.

In other embodiments, other betaines can be used, such as, by way of non-limiting example, glycine betaine, β-alanine betaine, proline betaine, choline-o-sulfate betaine, coco amidopropyl betaine, coco betaine, C18:1 betaine (oleyl betaine), C18:1 amidopropyl betaine (oleamidopropyl betaine), coco sulfo betaine, C12 betaine (lauryl betaine), wheat germ betaine, cocamidopropyl hydroxysultaine, octyl betaine, capryloamidopropyl betaine, lauramidopropyl betaine, isostearamidopropyl betaine, wheat germ amidopropyl betaine, lauryl hydroxy sultaine, and combinations thereof. While these betaines can also be synthesized by any way known in the art, they are also commercially available. For example, coco amidopropyl betaine (known chemically as N-(coco alkyl)amido propyl dimethyl betaine, CAS number 61789-40-0) is commercially available in the form of Mackam 35, from the Mcintyre Group, IL, USA, or in the form of Amphosol CA from the Stepan Company, USA. Coco betaine is commercially available in the form of Mackam CB-35 from the Mcintyre Group, Ltd., USA; C18:1 betaine is commercially available in the form of Chembetaine OL-30 from Chemron, USA; C18:1 amidopropyl betaine is commercially available in the form of Mackam HV from the McIntyre Group, Ltd., IL, US; coco sulfo betaine is commercially available in the form of chembetaine CAS from Chemron, USA; C12 betaine is commercially available in the form of Mackam LB-35 from the McIntrye Group, Ltd., IL, USA; wheat germ amidopropyl betaine is commercially available in the form of Mackam WGB from the McIntyre Group Ltd., IL, USA; and cocamidopropyl hydroxysultaine (CAS 68139-30-0) is commercially available in the form of Mackam CBS-50 from the McIntyre Group Ltd., IL, USA.

Additionally, as noted above, the composition can include at least one solvent which can be any compound that causes the granular betaine composition to dissolve (if the betaine composition is granular in form), or that disperses the betaine such that the concentration of the betaine is decreased without affecting the pesticidal effectiveness of the betaine (if the betaine is in liquid form). In one exemplary embodiment, the at least one solvent can be any chemical compound whose molecules contain a hydroxyl group bonded to a carbon atom, such as, for example, methanol or ethanol. Alternatively, or in addition, the at least one solvent can be water, propylene glycol, glycerol, isopropyl alcohol, tetrahydrofufuryl alcohol

The composition can be available in a concentrated or ready-to-use (RTU) form. Regardless of the form in which the composition is presented, it should include an amount of betaine that is effective to treat the particular bacterial and fungal plant or plant product pathogen or pathogens, however, in an exemplary embodiment the betaine concentration is in the range of about 0.001% ai to 1.00% ai, and more preferably in the range of about 0.005% ai to 0.50% ai. Specific exemplary concentrations of the betaine as applied to plants and plant products include 0.005% ai, 0.01% ai, 0.02% ai, 0.025% ai, 0.035% ai, 0.05% ai, 0.1% ai, and 0.2% ai. Moreover, the pH of the applied composition can be adjusted to be acidic, alkaline, or neutral, depending upon the particular needs of the user. An exemplary pH is in the range of about 6 to 7.

One skilled in the art will appreciate that the resulting betaine compositions disclosed herein are not only pesticidally effective, but also residual in that they do not easily wash off of the leaves during rain, and thus can protect against bacterial and fungal pathogens during and after rainy weather.

The composition may optionally include other active ingredients and/or plant or plant product treatment compounds, such as other fungicides, insecticides, metal and/or metal ions, or other compounds. For example, in one embodiment, at least one additional fungicide can be added to the composition. In an exemplary embodiment, the composition includes one additional fungicide, however the composition can also include additional fungicides. While the additional fungicide(s) can be any other fungicide known in the art, in one embodiment, the fungicide can be copper preparations, fatty acids and/or salts, sulfur preparations, neem extracts, sodium and potassium carbonates, essential oils, mineral oils, vegetable oils, and combinations thereof. In another embodiment, the fungicide can be a lecithin, sodium bicarbonate, phosphate salt, silica, silica salts, essential oils, kaolin clays, Thiram, zineb, ziram, and combinations thereof.

The betaine concentration in a composition having at least one betaine as well as at least one other fungicide can vary depending upon the particular needs of the user, the particular plant or plant product, and the particular bacterial or fungal pathogen(s), however the betaine is preferably used in the concentration ranges noted above. Moreover, concentration of the at least one additional fungicide in the composition can also vary depending upon the particular needs of the user, and in an exemplary embodiment, the composition has a concentration in the range of about 0.001% ai to 2.0% ai of the additional fungicide. One skilled in the art will appreciate that the addition of another fungicide can assist in the treatment of bacterial and fungal plant or plant product pathogens.

In another embodiment, at least one insecticide can be added to the betaine composition. In exemplary embodiment, the composition can include one insecticide, however the composition can also include additional insecticides. While any insecticide that will not damage the plant or plant product or adversely react with the betaine can be used, in one embodiment, the insecticide can be a natural pyrethrum or a pyrethroid. Exemplary natural pyrethrums and pyrethroids include allethrin, alphamethrin, bioresmethrin, byfenthrin, cycloprothrin, cyfluthrin, decamethrin, cyhalothrin, cypermethrin, deltamethrin, fenpropathrin, fenfluthrin, fenvalerate, flucythrinate, flumethrin, fluvalinate, permethrin, resmethrin and tralomethrin. Other insecticides include avermectins, spinosyns, Bacillus spp. including B. thuringensis, fatty acid salts (Insecticidal soaps), rotenone, sodium fluoride, Cryolite, tar oils, Verticillium lecanii, petroleum oils, vegetable oils, essential oils, and combinations thereof.

The betaine concentration in a composition having at least one betaine as well as at least one insecticide can vary depending upon the particular needs of the user, the particular plant or plant product, and the particular bacterial or fungal pathogen(s), however the betaine is preferably used in the concentration ranges noted above. Moreover, concentration of the insecticide in the composition can also vary depending upon the particular needs of the user, in an exemplary embodiment, the composition has a concentration in the range of about 0.001% ai to 2.0% ai of the other insecticide. One skilled in the art will appreciate that the addition of an insecticide to the betaine composition may be useful to eliminate the need for the preparation and delivery of a separate insecticidal treatment to the plant or plant product, thus saving the user both time and cost.

In another embodiment disclosed herein, at least one metal and/or metal ion can be added to the betaine composition to improve residual action. In an exemplary embodiment, the composition includes one metal and/or metal ion, however in other embodiments, the composition can include several metals and/or metal ions. While the at least one metal and/or metal ion can be any metal and/or metal ion useful in botanical applications, in an exemplary embodiment, the metal and/or metal ion can be selected from the group consisting of calcium, magnesium, manganese, iron, copper, nickel, zinc, aluminum, silver, titanium, and combinations thereof.

The betaine concentration in a composition having at least one betaine as well as at least one metal or metal ion can vary depending upon the particular needs of the user, the particular plant, plant product, and the particular bacterial or fungal pathogen(s), however the betaine is preferably used in the concentration ranges noted above. Moreover, concentration of the metal or metal ion in the solution can also vary depending upon the particular needs of the user, in an exemplary embodiment, the composition has a concentration in the range of about 0.01% ai to 2.0% ai of the metal and/or a metal ion. One skilled in the art will appreciate that the addition of a metal and/or a metal ion to the betaine composition maybe useful to eliminate the need for the preparation and delivery of an additional treatment to the plant or plant product, thus saving the user both time and cost.

One skilled in the art will further appreciate the composition can also include a variety of other plant or plant product treatment compounds depending upon the particular needs of the user. Such additional compounds include, but are not limited to, growth regulators, fertilizers, fungicides, thickening agents, humectants, antioxidants, surfactants, stabilizing agents, wetting agents, fungicide synergists, sequestrants, dyes, insecticides, miticides, and combinations thereof. Alternatively, the betaine composition can include any combination of the plant or plant product treatment compounds disclosed above, e.g., the betaine composition can include at least one other fungicide and at least one insecticide, the betaine composition can include at least one insecticide and at least one metal or metal ion, or the betaine composition can include at least one metal or metal ion and at least one other fungicide. Alternatively, the betaine composition can include at least one other fungicide, at least one insecticide, and/or at least one metal and/or metal ion, as well as at least one of the other plant or plant product treatment compounds noted above.

One skilled in the art will appreciate that the composition of the invention can be applied to a variety of vegetation, including plants, trees, shrubs, etc. The composition can also be applied to cut or harvested plants, fruits, and vegetables, and to other plant products such as lumber. Moreover, the composition of the invention can be used to treat plant and plant product disease and infection caused by bacterial and/or fungal pathogens, and it can be used to prevent such infections.

As noted above, methods for preparing a betaine composition are also disclosed herein. While this method can be used to create a betaine composition using any of the betaines mentioned above, for purposes of example only, the preparation of a betaine composition using cetyl betaine is described. While the cetyl betaine composition can be prepared in a variety of ways, in one embodiment, the composition is prepared by adding a desired amount of at least one solvent (e.g., water) to a vessel, followed by the commercially available form of cetyl betaine (e.g., De Taine PB). The solution is then stirred such that a substantially homogeneous composition is formed having a cetyl betaine concentration in the desired range (e.g., in the range of about 0.001% ai to 1.00% ai, or in the range of about 0.005% ai to 0.50% ai). Alternatively, the solution can be formed from granular cetyl betaine that is dissolved in at least one solvent (such as those listed above), or the solution can be formed from a cetyl betaine that is synthesized by any means known in the art.

Once a solution having a pesticidally effective betaine concentration is attained, the solution can be applied to plants and plant products any way known in the art. While the treatment can occur any number of times, it has been found that multiple treatments are effective in decreasing the effect of bacterial and fungal plant or plant product pathogens. Thus, in an exemplary embodiment, a plant or plant product can be retreated every seven to ten days for the plant product or the life of the plant. One skilled in the art will appreciate that such a treatment protects the existing leaves and fruit, as well as new leaves and fruit on growing plants. Moreover, one skilled in the art will appreciate that such a treatment protects plant products, such as lumber, from sapstain and smut.

The following non-limiting examples serve to further describe the invention. In all of the examples, the percent of active ingredient is on a weight percent basis.

### EXAMPLE 1

### Field Test of Betaines to Control Blackspot on Altissimo Roses

The purpose of this test was to evaluate various betaines for controlling rose blackspot (Diplocarpon rosae) on Altissimo roses under field conditions. Following formation of compositions of cetyl betaine, cocobetaine, and coco amidopropyl betaine using the commercially available forms of the betaines as disclosed herein as well as formation of a standard 0.2% sulfur solution, the compositions/solution were sprayed to run off onto mature Altissimo rose plants. Nine plants were used in each treatment, and the plants were resprayed every 7 to 10 days for over a 100 day period.

Table 1, below, illustrates the results obtained from treatments of cetyl betaine at various concentrations ranging from about 0.020% ai to 0.100% ai, as well as cocobetaine at a 0.05% ai concentration and coco amiodopropyl betaine at a 0.10% ai concentration.

TABLE 1
Effect of various betaines on the development of rose blackspot
(Diplocarpon rosae) on Altissimo roses

Leaflets with
Blackspot (%)
(DAT = Days
After Treatment)

| Compound % ai | 75 DAT | 102 DAT |
|---|---|---|
| Cetyl betaine 0.100% | 0.6 | 0.4 |
| Cetyl betaine 0.050% | 0.0 | 0.0 |
| Cetyl betaine 0.035% | 0.4 | 0.5 |
| Cetyl betaine 0.020% | 1.5 | 1.3 |
| Cetyl betaine 0.010% | 6.0 | 19.0 |
| Cocobetaine 0.05% | 2.9 | 9.5 |
| Coco amidopropyl betaine | 0.7 | 5.6 |
| 0.10% | | |
| Sulfur 0.2% | 0.8 | 1.5 |
| Non-treated | 10.1 | 18.3 |

### EXAMPLE 2

### Field Test of Betaines to Control Blackspot on Pink Parfait Roses

The purpose of this test was to evaluate various betaines for controlling rose blackspot (Diplocarpon rosae) on Pink Parfait roses under field conditions. This test was similar to that as described in Example 1 (e.g., the same compositions, and spraying times were used), only with four plants being used in each treatment.

Table 2 illustrates the results obtained.

TABLE 2
Effect of various betaines on the development of rose blackspot
(Diplocarpon rosae) on Pink Parfait roses

Leaflets with
Blackspot (%)
(DAT = Days
After Treatment)

| Compound % ai | 75 DAT | 102 DAT |
|---|---|---|
| Cetyl betaine 0.035% | 1.8 | 2.9 |
| Cocobetaine 0.05% | 9.5 | 20.3 |
| Coco amidopropyl betaine | 8.7 | 35.7 |
| 0.10% | | |
| Non-treated | 47.6 | 91.0 |

### EXAMPLE 3

### Field Test of Betaines to Control Rust on Black Currants

The purpose of this test was to evaluate 6 betaines for controlling rust (Cronartium ribicola) on black currant. Following formation of compositions of Coco betaine, C16 betaine, C18:1 betaine, Coco amidopropyl betaine, C18:1 amidopropyl betaine, and Coco sulfo betaine having varying betaine concentrations (using the commercially available forms of the betaines as discussed herein and a water solvent), and a copper octanoate standard (formed from a commercially available form entitled “Soap Shield” from Gardens Alive, Ind., USA), the compositions/solution were sprayed to run off onto eight-year-old black currants. Every treatment had nine plants, and the plants were resprayed every 7 to 10 days.

Table 3 illustrates the results obtained.

TABLE 3
Effect of various betaines on the development of rust on black currant

| | Concentration | Rust Sori Per |
|---|---|---|
| | (% ai) | 9 Plants |
| Coco betaine | 0.05% | 200 |
| C16 betaine | 0.10% | 380 |
| C18:1 betaine | 0.10% | 550 |
| Coco amidopropyl betaine | 0.10% | 2154 |
| C18:1 amidopropyl betaine | 0.10% | 2121 |
| Coco sulfo betaine | 0.10% | 332 |
| Copper octanoate | 0.10% | 135 |
| Non-treated | | 6931 |

### EXAMPLE 4

### Greenhouse Test of Betaines for Controlling Powdery Mildew on Dandelion

The purpose of this test was to evaluate the control of powdery mildew (Sphaerotheca fuliginea) on dandelion (Taraxacum officinale). Compositions of C12 betaine, Coco betaine, C16 betaine, C18:1 betaine, Coco amidopropyl betaine, C18:1 amidopropyl betaine, and Coco sulfo betaine were formed using the commercially available forms of the betaines as disclosed herein. Additionally, a sulfur standard was prepared using a commercially available form of sulfur (Red Ball EM-53) from International Chem. Inc., USA.

For each treatment, twelve 20 cm diameter dandelions were used, and at the start of the test, all of the leaves were trimmed off of the plants. The test evaluated disease development on fully formed leaves. Each composition was sprayed to run off the plants, and resprayed 3 times every 7 days. The plants were also reinoculated by placing diseased dandelions amongst the test plants.

The results obtained are shown in Table 4.

TABLE 4
Effect of various betaines on the development of powdery mildew on
dandelions

| | | Leaf Area |
|---|---|---|
| | Concentration | Colonized by |
| | (% ai) | Powdery Mildew (%) |
| C12 betaine | 0.1% | 0.6 |
| Coco betaine | 0.1% | 0.0 |
| C16 betaine | 0.1% | 0.3 |
| C16 betaine | 0.2% | 0.0 |
| C18:1 betaine | 0.1% | 2.3 |
| Coco amidopropyl betaine | 0.1% | 0.4 |
| C18:1 amidopropyl betaine | 0.1% | 0.9 |
| Sulfur 0.2% | 0.2% | 0.0 |
| Water | | 18.8 |
| Non-treated | | 23.2 |

### EXAMPLE 5

### Evaluation of Cetyl Betaine for Controlling Cucumber Powdery Mildew

The purpose of this test was to assess the effectiveness of cetyl betaine for controlling cucumber powdery mildew. Following formation of cetyl betaine compositions having varying concentrations (using commercially available form of cetyl betaines as disclosed herein), six two-week-old Revenue cucumber plants/per treatment were sprayed to run off with the various solutions. Cucumber plants heavily colonized by powdery mildew were placed adjacent to the test plants to provide a source of inoculum, and the test plants were re-sprayed weekly. The results obtained 26 days after the start of the test are shown below in Table 5.

TABLE 5
Effect of various betaines on the development of powdery mildew on
cucumber plants

Area of Primary
and Secondary
Leaves
Colonized (%)
Leaf

| | 1° | 2° |
|---|---|---|
| Compound % ai | 26 d | 26 d |
| Cetyl betaine 0.10% (A) | 2 | 6 |
| Cetyl betaine 0.05% (B) | 11 | 5 |
| Cetyl betaine 0.025% (C) | 33 | 14 |
| Non-treated | 100 | 100 |

### EXAMPLE 6

### Greenhouse Evaluation of Cetyl Betaine for Controlling Cucumber Mildew

The purpose of this test was to evaluate cetyl betaine for the control cucumber powdery mildew. Following formation of a cetyl betaine composition using the commercially available form of cetyl betaine disclosed herein, five two-week-old Revenue cucumber plants/per treatment were sprayed to run off, and resprayed weekly. The results obtained are shown below in Table 6.

TABLE 6
Effect of cetyl betaine on the development of powdery
mildew on cucumber plants

| | | | | | Area of Second Leaf | | |
|---|---|---|---|---|---|---|---|
| | Area of First Leaf Colonized | | | | Colonized (%) After | | |
| | (%) | | | | X Days | | |
| | After X Days After Start (d) | | | | After Start (d) | | |
| | 14 d | 19 d | 28 d | 32 d | 19 d | 28 d | 32 d |
| Cetyl | 0 | 0 | 7 | 11 | 0 | 1 | 4 |
| betaine | | | | | | | |
| 0.05% ai | | | | | | | |
| Non- | 4 | 41 | 99 | 100 | 0 | 54 | 95 |
| treated | | | | | | | |

### EXAMPLE 7

### Greenhouse Evaluation of Cetyl Betaine for Controlling Cucumber Mildew

The purpose of this test was to evaluate cetyl betaine for controlling cucumber powdery mildew. Following formation of cetyl betaine compositions of varying concentrations using commercially available forms of cetyl betaines as disclosed herein, nine two-week-old Revenue cucumber plants/per treatment were sprayed to run off, and re-sprayed weekly. Cucumber plants heavily colonized by powdery mildew were placed adjacent to the test plants as a source of inoculum. The results obtained are shown below in Table 7.

TABLE 7
Effect of cetyl betaine on the development of powdery mildew on
cucumber plants

| | Area of First | | | Area of |
|---|---|---|---|---|
| | Leaf Colonized | | | Second Leaf |
| | (%) After X | | | Colonized (%) |
| | Days After Start (d) | | | After 27 Days |
| | 14 d | 20 d | 27 d | After Start |
| Cetyl | 0 | 8 | 13 | 2 |
| betaine 0.10% | | | | |
| (A) | | | | |
| Cetyl | 1 | 16 | 36 | 12 |
| betaine | | | | |
| 0.035% (B) | | | | |
| Non- | 6 | 49 | 83 | 38 |
| treated | | | | |

### EXAMPLE 8

### Effect of 4 Betaines on the Germination of Botrytis and Monilinia Spores

The purpose of this test was to evaluate the fungicidal activity of four betaine surfactants against the fungi Botryis cinerea and Monilinia fructicola. Botrytis cinerea causes gray mold of strawberries and Monilinia fructicola causes brown mold of plum. Compositions of cocobetaine, sulfo cocobetaine, coco amidopropyl betaine, and cetyl (C16) betaine having concentrations of 0.10% ai and 0.01% ai were formed using the commercially available forms of the betaines, as disclosed herein.

The solutions were sprayed onto water agar (7.5 g agar/L) in Petri dishes. After drying, agar was sprayed with spore suspensions (105 spores/mL) of the 2 fungi, and the plates were incubated for 22 hours at 20° C. The results obtained are shown in Table 8 below.

TABLE 8
Effect of various betaines on the germination of Botrytis cinerea and
Monilinia fructicola spores

| | |
|---|---|
| Betaine | Spore |
| Concentration | Germination (% ai) |

| | (% ai) | Botrytis | Monilinia |
|---|---|---|---|
| Cetyl betaine | 0.10 | 0 | 0 |
| Cetyl betaine | 0.01 | 38 | 94 |
| Cocoamidopropyl | 0.10 | 47 | 30 |
| betaine | | | |
| Cocoamidopropyl | 0.01 | 46 | 100 |
| betaine | | | |
| Cocobetaine | 0.10 | 4 | 49 |
| Cocobetaine | 0.01 | 62 | 100 |
| Sulfo | 0.10 | 33 | 98 |
| cocobetaine | | | |
| Sulfo | 0.01 | 70 | 100 |
| cocobetaine | | | |
| Non-treated | | 70 | 99 |

### EXAMPLE 9

### Effect of Cetyl Betaine Concentration on Infection of Tropicana Rose Leaves by Diplocarpon Rosae

The purpose of this test was to assess the ability of cetyl betaine to prevent the infection of rose leaves by the blackspot fungus Diplocarpon rosae. Following composition formation using a commercially available for of cetyl betaine, compositions of cetyl betaine in water were sprayed to run off onto single Tropicana rose plants. After drying, 4 leaves were harvested from each treatment. Twenty 15 mm diameter leaf discs were removed from the leaves of each treatment and placed onto water agar in Petri dishes. A 10 μL inoculum droplet of a Diplocarpon rosae spore suspension (105 spores/mL) was placed on each leaf disc, and removed after 24 hours. Observations were made after 6 days, at which time black lesions were visible on the non-treated leaf discs, typical of the disease rose blackspot.

The results obtained are shown in Table 9 below.

TABLE 9
Effect of cetyl betaine concentration of the infection of rose
leaves by Diplocarpon rosae (rose blackspot)

| Compound % ai | Diseased Leaf Discs (#/20) |
|---|---|
| Cetyl betaine 0.100% | 0 |
| Cetyl betaine 0.050% | 0 |
| Cetyl betaine 0.035% | 1 |
| Cetyl betaine 0.020% | 1 |
| Cetyl betaine 0.010% | 0 |
| Cetyl betaine 0.005% | 0 |
| Cocobetaine 0.05% | 3 |
| Amidopropyl betaine 0.10% | 5 |
| Non-treated | 20 |

### EXAMPLE 10

### Residual Activity of Cetyl Betaine

The purpose of this test was to study the residual activity of cetyl betaine based on the ability of the various treatments to prevent infection of Reine des Violettes rose leaves on potted by the blackspot fungus Diplocarpon rosae. Following preparation and spraying of a betaine composition (as disclosed herein) and after drying, four leaves were removed from the treatment for the “before watering” treatment. The plants were then watered with an oscillating lawn sprinkler for 30 minutes, during which time 5.9 mm of water was collected in a rain gauge. Four additional leaves were collected for the “after watering” treatments. Twenty 15 mm diameter leaf discs were removed from the leaves of the treatment and placed onto water agar in Petri dishes. A 10 μL droplet of a Diplocarpon rosae spore suspension (10⁵ spores/mL) was placed on each leaf disc, and the droplet was removed after 24 hours. Observations were made after six days, shown in Table 10.

TABLE 10
Residual activity of cetyl betaine as assessed by the infection of rose
leaves by Diplocarpon rosae (rose blackspot)

Infected
Leaves (#/20)

| | Before | After |
|---|---|---|
| | Watering | Watering |
| Cetyl betaine 0.1% (A) | 0 | 2 |
| Non-treated | 20 | 18 |

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety. Further, unless otherwise noted, all percentages referenced herein are percentages by weight.

What is claimed is:

1. A plant or plant product treatment composition, comprising:
a pesticidally effective amount of at least one betaine; and
at least one solvent,
wherein the pesticidal composition is effective to kill bacterial and fungal plant pathogens without damaging plants or degrading plant products.

2. The composition of claim 1, wherein the at least one betaine has a linear or branched alkyl group.

3. The composition of claim 2, wherein the alkyl group has about 5 to 20 carbon atoms.

4. The composition of claim 1, wherein the at least one betaine is present at a concentration in the range of about 0.001% ai and 0.10% ai.

5. The composition of claim 1, wherein the at least one betaine is selected from the group consisting of glycine betaine, β-alanine betaine, proline betaine, choline-o-sulfate betaine, coco amidopropyl betaine, coco betaine, C18:1 betaine (oleyl betaine), C18:1 amidopropyl betaine (oleamidopropyl betaine), coco sulfo betaine, C12 betaine (lauryl betaine), wheat germ betaine, cocamidopropyl hydroxysultaine, octyl betaine, capryloamidopropyl betaine, lauramidopropyl betaine, isostearamidopropyl betaine, wheat germ amidopropyl betaine, lauryl hydroxy sultaine, and combinations thereof.

6. The composition of claim 1, wherein the at least one betaine is cetyl betaine.

7. The composition of claim 1, wherein the at least one solvent is selected from the group consisting of methanol, ethanol, water, propylene glycol, glycerol, isopropyl alcohol, tetrahydrofufuryl alcohol, and combinations thereof.

8. The composition of claim 1, further comprising at least one additional fungicide selected from the group consisting of copper preparations, fatty acids and/or salts, sulfur preparations, neem extracts, sodium and potassium carbonates, essential oils, mineral oils, vegetable oils, and combinations thereof.

9. The composition of claim 1, further comprising at least one insecticide selected from the group consisting of natural pyrethums, pyrethroids, spinosyns, and microbial compounds including Bacillus spp., and combinations thereof.

10. The composition of claim 1, further comprising at least one metal ion or a mixture of metal ions selected from the group consisting of calcium, magnesium, manganese, iron, copper, nickel, zinc, aluminum, silver, titanium, and combinations thereof.

11. The composition of claim 1, further comprising at least one other compound selected from the group consisting of growth regulators, fertilizers, fungicides, thickening agents, humectants, antioxidants, surfactants, stabilizing agents, wetting agents, fungicide synergists, sequestrants, dyes, insecticides, miticides, and combinations thereof.

12. A method for the control of plant or plant product pathogens, comprising:
providing a composition having a pesticidally effective amount of at least one betaine; and
contacting a plant or a plant product with a pesticidally effective amount of the composition, such that the plant or plant product is protected against plant or plant product pathogens without causing injury.

13. The method of claim 12, wherein the at least one betaine has a linear or branched alkyl group.

14. The method of claim 12, wherein the alkyl group has about 5 to 20 carbon atoms.

15. The method of claim 12, wherein the at least one betaine is present at a concentration in the range of about 0.001% ai and 0.10% ai.

16. The method of claim 12, wherein the at least one betaine is selected from the group consisting of glycine betaine, β-alanine betaine, proline betaine, choline-o-sulfate betaine, C18:1 betaine (oleyl betaine), C18:1 amidopropyl betaine (oleamidopropyl betaine), coco sulfo betaine, C12 betaine (lauryl betaine), wheat germ betaine, cocamidopropyl hydroxysultaine, octyl betaine, capryloamidopropyl betaine, lauramidopropyl betaine, isostearamidopropyl betaine, wheat germ amidopropyl betaine, lauryl hydroxy sultaine, and combinations thereof.

17. The method of claim 11, wherein the at least one betaine is cetyl betaine.

18. The method of claim 12, wherein the composition further includes at least one solvent.

19. The method of claim 18, wherein the at least one solvent is selected from the group consisting of methanol, ethanol, water, propylene glycol, glycerol, isopropyl alcohol, tetrahydrofufuryl alcohol, and combinations thereof.

20. The method of claim 12, wherein the composition further includes at least one additional fungicide selected from the group consisting of copper preparations, fatty acids and/or salts, sulfur preparations, neem extracts, sodium and potassium carbonates, essential oils, mineral oils, vegetable oils, and combinations thereof.

21. The method of claim 12, wherein the composition further includes at least one insecticide selected from the group consisting of natural pyrethrums, pyrethroids, spinosyns and microbial compounds including Bacillus spp., and combinations thereof.

22. The method of claim 12, wherein the composition further includes at least one metal ion or a mixture of metal ions selected from the group consisting of calcium, magnesium, manganese, iron, copper, nickel, zinc, aluminum, silver, titanium, and combinations thereof.

23. The method of claim 12, wherein the composition further includes at least one other compound selected from the group consisting of growth regulators, fertilizers, fungicides, thickening agents, humectants, antioxidants, surfactants, stabilizing agents, wetting agents, fungicide synergists, sequestrants, dyes, insecticides, miticides, and combinations thereof.
